(19) United States
(12) Patent Application Publication
(10) Pub. No.: US 2008/0046927 A1
(43) Pub. Date: Feb. 21, 2008

(54) Information displaying apparatus, information displaying method, and recording medium where information displaying program is recorded

(75) Inventors: Noriaki Yoshikawa, Ohta-ku (JP); Harutoshi Kazamatsuri, Ohta-ku (JP); Hideyuki Uchiyama, Ohta-ku (JP); Hiroshi Kida, Ohta-ku (JP); Yoshikazu Nagano, Ohta-ku (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku (JP)

(21) Appl. No.: 11/785,663

(22) Filed: Apr. 19, 2007

(30) Foreign Application Priority Data
Apr. 20, 2006 (JP) 2006-116992

(51) Int. Cl. G06F 13/00; G06F 3/00; H04N 5/445

(52) U.S. Cl. 725/39; 725/56

(57) ABSTRACT

Receivable channels in a program guide G used for selecting a program are arranged using the longitudinal axis of the program guide G itself as a time base and using the horizontal axis as a channel axis. A channel being currently viewed is disposed at the left end. From the right side of the channel, the other channels are arranged in decreasing order of the viewing frequency from left to right, and programs of the other channels are disposed along the time base.

### BACKGROUND OF THE INVENTION

1. Field of the Invention

The present invention belongs to the technical field of an information displaying apparatus, an information displaying method, and a recording medium where an information displaying program is recorded. More particularly, the invention belongs to the technical field of an information displaying apparatus, an information displaying method, and a recording medium where an information displaying program is recorded for displaying a program guide as a list of programs to be broadcasted.

2. Related Background Art

In recent years, recording apparatuses and the like for recording a broadcasted television program are widely used. For programming of recordings in some of the recording apparatuses, a so-called EPG (Electronic Program Guide) as a list of the details of programs (program names, broadcast channels, performers, and the like) being currently broadcasted or to be broadcasted is used.

The conventional program guide display includes display of the details of programs in all of channels which can be received by using a television apparatus itself or a tuner, display by kinds of broadcasting such as television broadcast data and radio broadcast data, and display of only an arbitrary channel which is preset by the viewer.

The conventional techniques, however, do not consider changing of the order of displaying channels, and the display order is always fixed. In this case, for example, channels which are usually hardly watched are also listed. Consequently, there are problems such that an operation for selecting a channel desired to be viewed has to be performed, and the selecting operation requires time.

To solve the problems, the technique disclosed in Japanese Unexamined Patent Publication (JP-A) No. H8-139619 (FIG. 21 and the like) is developed. In the technique described in JP-A No. H8-139619, broadcast station names on a day-of-week unit are displayed in a line in viewing frequency order and along broadcast time.

In the technique described in JP-A No. H8-139619, however, only the broadcast station names on the day-of-week unit are displayed in a line in viewing frequency order. Consequently, it has a problem such that the viewer cannot generally grasp programs of the other broadcast stations broadcasted at the same broadcast time.

Particularly, at the time of programming a recording of a program, to grasp programs of the broadcast stations in the same time period other than the broadcast station being currently displayed, the viewer has to switch a display screen. It is very inconvenient for the viewer, particularly, when the viewer is an elderly person or young child.

The present invention has been achieved in consideration of the above problem and an object of the invention is to provide an information displaying apparatus, an information displaying method, and a recording medium where an information displaying program is recorded capable of displaying programs being broadcasted or to be broadcasted so as to be generally easily viewed while contributing to the convenience of the viewer.

### SUMMARY OF THE INVENTION

In order to solve the above problems, the invention according to claim 1 relates to an information displaying apparatus for displaying a list of programs as a program guide on a channel unit basis on a display device, comprising:

a frequency calculating device which calculates frequency of viewing on the channel unit basis;

a screen generating device which generates, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and

a display control device which displays the generated program guide screen on the display device,

wherein the order of displaying the channels in the channel group display columns is either ascending order or descending order of the calculated frequency.

In order to solve the above problems, the invention according to claim 10 relates to an information displaying method executed in an information displaying apparatus for displaying a list of programs as a program guide on a channel unit basis on a display device, comprising:

a frequency calculating process of calculating frequency of viewing on the channel unit basis;

a screen generating process of generating, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and

a display control process of displaying the generated program guide screen on the display device,

wherein the order of displaying the channels in the channel group displaying columns is either ascending order or descending order of the calculated frequency.

In order to solve the above problems, the invention according to claim 11 relates to a recording medium where an information displaying program is computer-readably recorded,

the program being for making a computer for controlling display in a display device function as the information displaying apparatus

wherein the information displaying apparatus is for displaying a list of programs as a program guide on a channel unit basis on a display device, comprising:

a frequency calculating device which calculates frequency of viewing on the channel unit basis;

a screen generating device which generates, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and

a display control device which displays the generated program guide screen on the display device,

wherein the order of displaying the channels in the channel group display columns is either ascending order or descending order of the calculated frequency.

### BRIEF DESCRIPTION OF THE DRAWINGS

FIG. 1 is a block diagram showing a schematic configuration of a television apparatus according to an embodiment of the present invention;

FIG. 2 is a diagram illustrating the details of a program guide in the embodiment;

FIGS. 3A and 3B are flowcharts showing process of displaying/updating the program guide in the embodiment; and

FIG. 4 is a diagram illustrating a mode of updating the program guide in the embodiment.

### DETAILED DESCRIPTION OF THE PREFERRED EMBODIMENTS

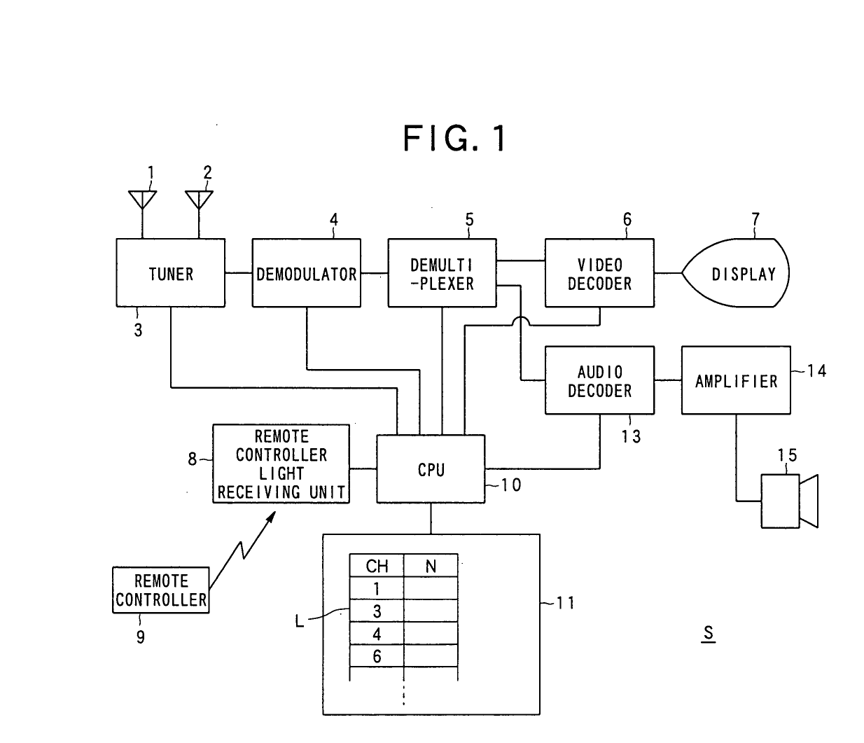

A preferred embodiment of the present invention will be described with reference to FIGS. 1 to 4. The embodiment relates to the case of applying the invention to a television apparatus capable of viewing a program digitally broadcasted while obtaining and utilizing an electronic program guide.

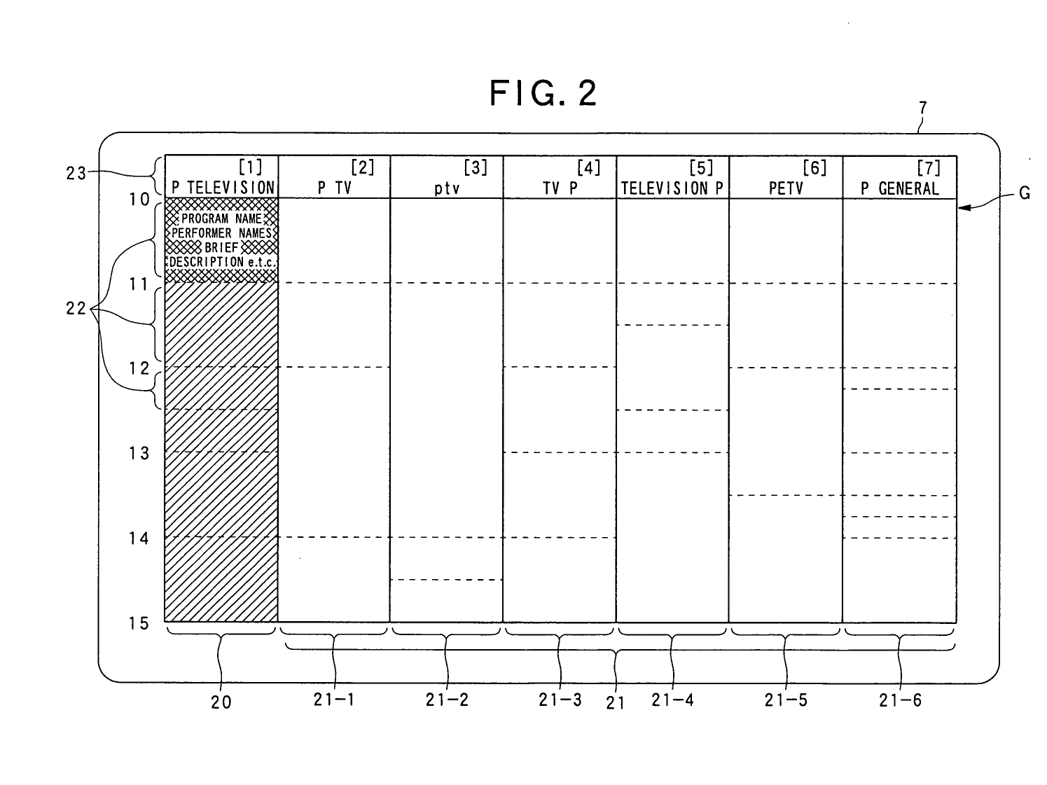

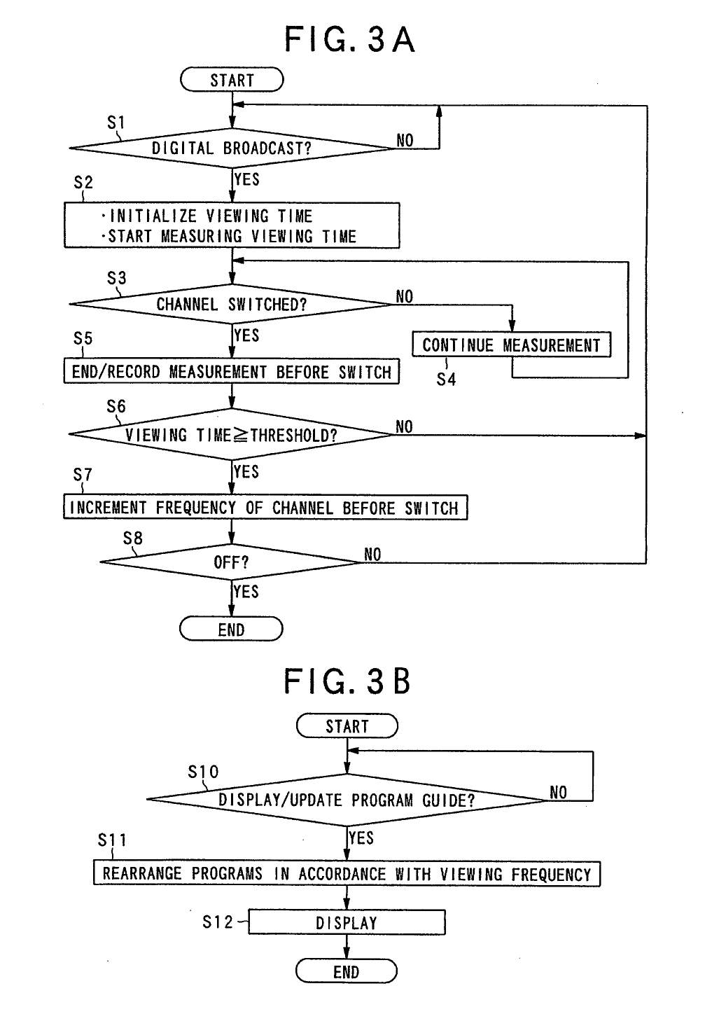

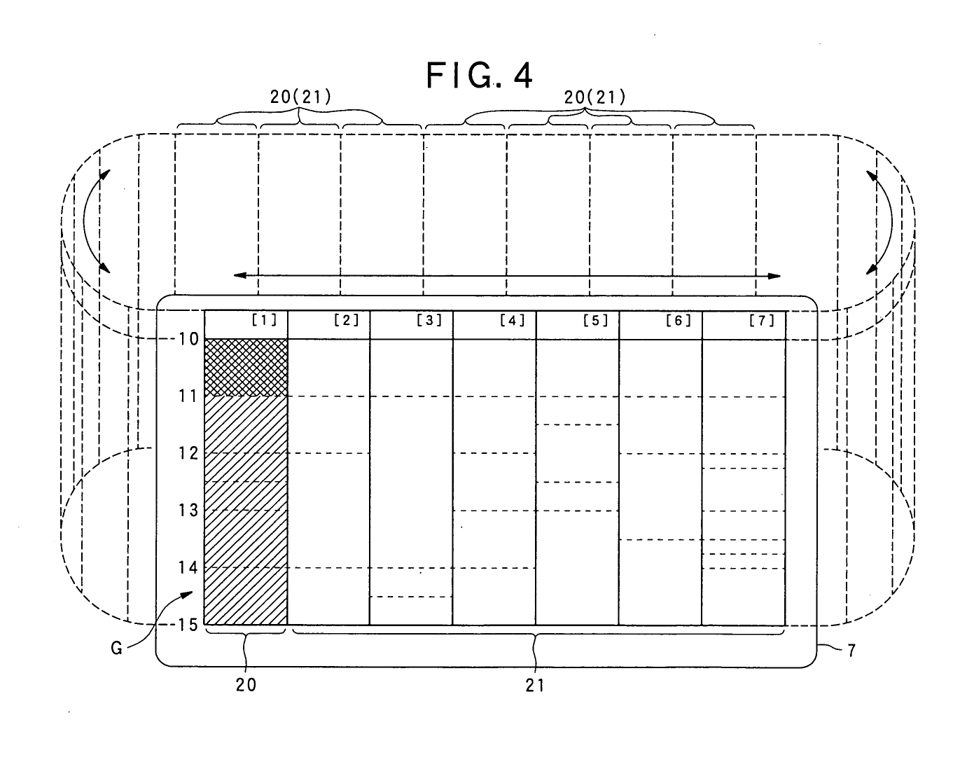

FIG. 1 is a block diagram showing a schematic configuration of a television apparatus according to an embodiment of the present invention. FIG. 2 is a diagram illustrating a program guide in the embodiment. FIGS. 3A and 3B are flowcharts showing the operations of the television apparatus. FIG. 4 is a diagram illustrating a mode of updating the program guide in the embodiment.

As shown in FIG. 1, a television apparatus S of the embodiment includes a tuner 3 to which a satellite antenna 1 and a terrestrial antenna 2 are connected, a demodulator 4, a demultiplexer 5, a video decoder 6, a display 7 as a display device such as a liquid crystal display or a CRT (Cathode Ray Tube), a remote controller light receiving unit 8, a remote controller 9 connected to the remote controller light receiving unit 8 by infrared light, a CPU 10 as a frequency calculating device, a screen generating device, and a display control device, a memory 11 including both a nonvolatile area and a volatile area, an audio decoder 13, an amplifier 14, and a speaker 15.

In the nonvolatile area in the memory 11, a viewing frequency list L indicative of viewing frequency information N which will be described later in each of channels in the digital broadcast is stored.

Next, general operation will be described.

First, airwaves for digital broadcast received by the satellite antenna 1 or terrestrial antenna 2 are demodulated by the tuner 3 and the demodulator 4, and the demodulated airwaves are output as a decoded signal to the demultiplexer 5.

Under control of the CPU 10, the demultiplexer 5 demultiplexes a sound signal and an image signal from the decoded signal, and outputs the sound and image signals to the audio decoder 13 and the video decoder 6, respectively.

Under control of the CPU 10, the video decoder 6 decodes the image signal and outputs the decoded signal to the display 7 to display an image corresponding to the image signal.

On the other hand, under control of the CPU 10, the audio decoder 13 decodes the sound signal. The decoded sound signal is amplified with preset amplification factor in the amplifier 14, and the amplified signal is output as corresponding sound from the speaker 15.

In the operations, the viewer executes the operations of switching the channel, the program guide, or the like with the remote controller 9. An operation signal corresponding to the operation is output to the CPU 10 via the remote controller light receiving unit 8.

On the basis of the operation signal, the CPU 10 generates control signals for controlling the components and outputs the control signals to the components while transmitting/receiving necessary information to/from the memory 11.

By the series of operations, the operations of the television apparatus S including a program guide displaying process which will be described later are realized.

The content of the program guide according to the invention displayed on the display 7 by a process to be described later will be stated with reference to FIG. 2.

A program guide G according to the invention has as its top line, as illustrated in FIG. 2, a channel display field 23 where receivable channels are arranged in a row.

A concrete program column using the longitudinal axis as time base and the horizontal axis as an axis along which channels (broadcast stations) are arranged is constructed below the channel display field 23. The program column shows a list of program information 22 indicative of the details of programs (concretely, for example, as shown in FIG. 2, the name of the program, performers, brief description of the program, and the like) broadcasted in the channels at times. The longitudinal axis is set as the time base and the horizontal axis is set as the channel axis for the reason that so-called TV program guides in general Japanese newspapers use the longitudinal axis as the time base and the horizontal axis as the channel axis.

First, at the left end of the program guide G, a viewing-channel display column 20 (hatched column in FIG. 2) displaying programs of a channel being currently viewed along the time base is displayed. On the right side of the column 20, other channel display columns 21-1 to 21-6 showing, along the time base, the details of programs in receivable channels other than the channel being viewed are disposed.

Channels in the other channel display columns 21-1 to 21-6 are arranged from left to right in the decreasing order of the value of the viewing frequency information N on the channel unit basis, which will be described later.

The program information 22 indicative of the programs of the channel currently selected by an operation of the remote controller 9 is displayed in a display mode different from that of the other program information 22 as shown by double hatching in FIG. 2.

Alternatively, the viewing channel display column 20 may be disposed as the rightmost column in the program guide G. On the left side of the viewing channel display column 20, the channel display columns 21-1 to 21-6 may be disposed from right to left in decreasing order of the value of the viewing frequency information N.

The viewer selects a necessary program by moving a not-shown cursor or the like displayed in the program guide G by operating the remote controller 9 in a state where the program guide G is displayed, so that the selected program is used for programming of recordings in the not-shown recording apparatus or the like.

Next, the processes for displaying the program guide G of the embodiment shown in FIG. 2 will be described concretely with reference to FIGS. 1 to 3A, and 3B.

As the processes for displaying the program guide G in the embodiment, first, a process for calculating the viewing frequency information N in each of the channels and storing it as a viewing frequency list L in the memory 11 is performed.

As shown in FIG. 3A, first, whether reception of the digital broadcast has started in the television apparatus S or not is determined (step S1). When the digital broadcast is received (YES in step S1), viewing time information corresponding to a channel being viewed is initialized and measurement of the viewing time is started (step S2).

In the measurement, whether an operation of switching the channel being currently viewed is executed by the remote controller 9 or not is always monitored (step S3). When the channel switching operation is not executed (NO in step S3), measurement of the viewing time of the same channel is continued while being integrated (step S4), and the program returns to the step S3.

On the other hand, when it is determined in step S3 that the channel switching operation is executed (YES in step S3), integration of the viewing time in the channel before the switch is stopped, and viewing time information indicative of the integrated viewing time is temporarily stored in the memory 11 (step S5).

Whether the viewing time indicated by the stored viewing time information is equal to or longer than preset threshold time or not is determined (step S6). When viewing is continued longer than the threshold time (YES in step S6), the value of the viewing frequency information N of the channel corresponding to the viewing time (that is, the channel whose program was viewed before the channels switching operation in the process of step S3) is incremented (step S7).

After that, whether an operation of finishing viewing in the television apparatus S is executed or not is determined (step S8). When the operation is executed (YES in step S8), the operation is finished. On the other hand, when the viewing is continued (NO in step S8), the program returns to the step S1 and the above-described processes are repeated.

On the other hand, when it is determined in step S6 that the viewing has been continued only for time less than the threshold time (NO in step S6), the viewing mode is not reflected in the value of the viewing frequency information N, the program returns to the step S1, and the above-described processes are repeated.

The reason why the viewing time integrated until then is compared with the threshold time in the process of the step S6 is because it is improper to reflect extremely short time of viewing of so-called zapping operation at the time of the channel selection into the viewing time integrated until then. The integrated viewing time can be arbitrarily and experimentally set as the threshold. For example, about five minutes is preferable as the threshold time.

The processes for actually displaying or updating the program guide G in the case where the viewing frequency information N is obtained on the channel unit basis by the above-described processes will be described concretely with reference to FIG. 3B.

As shown FIG. 3B, in the process of displaying/updating the program guide G, first, an instruction of newly displaying the program guide G (that is, activating the program guide G itself) or updating the program guide G being currently displayed is given or not is monitored (step S10). When the instruction is given (YES in step S10), the program information 22 at the timing is obtained via the antenna, a not-shown network, or the like, and the arrangement of the channels in the program guide G is determined with reference to the viewing frequency list L in the memory 11 (step S11).

The programs of the channel being currently viewed are arranged vertically along the time base in the program guide G, and the programs of the channels other than the channel being currently viewed are arranged in the determined arrangement on the channel unit basis in time order, thereby forming the program guide G shown in FIG. 2. The program guide G is displayed on the display 7 (step S12), and the process is finished.

The displaying/updating process shown in FIG. 3B is also applied not only to the above-described activation of the program guide G itself but also to the case of displaying programs of the other channels which cannot be displayed at once by scrolling the program guide G itself in the lateral direction in the display 7 as conceptually shown by the double-headed arrows in FIG. 4. At this time, when the column 20 displaying the channel being viewed is shown in the display range of the display 7, for example, the programs of the channels are arranged in the decreasing order of the value of the viewing frequency information N in the direction opposite to the scrolling direction when viewed from the column 20 displaying the channel being viewed. Even in the case where the column 20 displaying the channel being viewed is (conceptually) on the back side as shown in FIG. 4, the other channels are displayed as the program guide G on the display 7 while maintaining the order.

As described above, in the process of displaying/updating the program guide G and the configuration of the program guide G itself in the embodiment, the order of display on the channel unit basis is determined in accordance with the viewing frequency of the programs in the program guide G. Consequently, the easy-to-see and useful program guide G adapted to the taste of the viewer can be displayed.

Since the longitudinal axis of the program guide G is set as the time base, the horizontal axis of the program guide G is set as the channel axis and, further, the channel being viewed is also displayed, the following programs of the channel being viewed can be displayed so as to be easily viewed.

Further, when the display position of the channel being viewed is set to the leftmost column or the rightmost column, the following programs of the channel being viewed can be displayed so as to be more easily viewed.

Further, the programs of the other channels are displayed in the decreasing order of the viewing frequency adjacent to the channel being viewed. Consequently, the programs in the other channels can be displayed so as to be easily recognized.

At the time of calculating the viewing frequency, a channel whose viewing time is less than the threshold time is excluded. Consequently, a state where a channel is not substantially viewed such as a state where the viewer is selecting a channel is excluded so that the viewing frequency can be accurately calculated.

Further, since the viewing frequency at the present time is used as a reference and a program guide screen for the following time is generated, a list of programs can be displayed so as to be easily viewed using the present point as a center.

Moreover, the program guide G is updated only when an update of the program guide G is instructed. Consequently, the visibility of the program guide G can be prevented from becoming poor caused by unnecessary and high-frequent updating.

In the foregoing embodiment, the viewing frequency information N of the channel of the program being currently viewed is simply incremented. The viewing frequency information N of a channel corresponding to a program viewed every preset unit time (more concretely, every fifteen minutes, thirteen minutes, or one hour on the hour, as a timing when commercials are run) may be updated and used for updating the program guide G.

In this case, for example, the viewing frequency information N can be reflected in the program guide G every unit time. Therefore, for example, an operation of automatically changing channels other than a channel being viewed in the program guide G after lapse of the unit time can be performed.

With the configuration, the viewing frequency is calculated every unit time and every channel. Consequently, by calculating the viewing frequency not only on the channel unit basis but also every unit time, the taste of the viewer can be reflected more accurately in the viewing frequency.

Further, in the case of updating the program guide screen by using the viewing frequency information N every unit time corresponding to the timing only when the updating is instructed, the program guide can be displayed more accurately while maintaining visibility.

In the case of automatically updating the program guide G every unit time using the calculated viewing frequency, the program guide G can be automatically updated in accordance with time.

Although the present invention is applied to the case of viewing a program digitally broadcasted in the foregoing embodiment, obviously, the invention can be also applied to the case of viewing an analog broadcast program.

The term “viewing” in the foregoing embodiment and the like denotes not only viewing of one program being displayed on the display 7 but also viewing of each of programs displayed in two screens on the display 7, a program recorded by using the function of recording a program different from a program being viewed or a program recorded in the viewer's absence. Any of the recorded programs maybe reflected in the viewing frequency information N.

In the case of receiving, for example, a radio broadcast, the invention can be also applied to the case of programming recordings or the like by using a program guide of radio broadcast displayed on the display 7.

Further, the program corresponding to the flowcharts shown in FIG. 3 is recorded in an information recording medium such as a flexible disk or hard disk in a part corresponding to each of the apparatuses, or the program is obtained via the Internet or the like and recorded. By reading the program and executing it by a general computer, the computer can be utilized as the CPU 10 of the embodiment.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2006-116992 filed on Apr. 20, 2006 including the specification, claims, drawings and abstract is incorporated herein by reference in its entirety.

What is claimed is:

1. An information displaying apparatus for displaying a list of programs as a program guide on a channel unit basis on a display device, comprising:
a frequency calculating device which calculates frequency of viewing on the channel unit basis;
a screen generating device which generates, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and
a display control device which displays the generated program guide screen on the display device,
wherein the order of displaying the channels in the channel group display columns is either ascending order or descending order of the calculated frequency.

2. The information displaying apparatus according to claim 1,
wherein the channel group displaying columns include:
a column displaying a channel being currently viewed, where programs of the channel being currently viewed are displayed along the time base, and
columns displaying a group of other channels which are displayed subsequently from the column displaying the channel being viewed along the horizontal axis, and in each of which programs of the channels other than the channel being currently viewed are displayed along the time base, and
wherein the order of displaying the channels in the columns displaying the group of the other channels is the decreasing order of the calculated frequency from the column of displaying the channel being currently viewed.

3. The information displaying apparatus according to claim 2,
wherein the column displaying the channel being currently viewed is disposed at either the right or the left end of the channel group display columns.

4. The information displaying apparatus according to claim 1,
wherein the frequency calculating device calculates the frequency by accumulating the number of times of viewing a program for preset threshold time or longer on the channel unit basis.

5. The information displaying apparatus according to claim 1,
wherein the screen generating device determines the order of displaying the channels in the columns displaying the group of the other channels on the basis of the calculated frequency at the present time point, and generates the program guide screen.

6. The information displaying apparatus according to claim 1, further comprising:
an update instructing device used for instructing updating of the content of the program guide screen displayed; and
an updating device which executes the updating by using the calculated frequency only when the updating is instructed.

7. The information displaying apparatus according to claim 1,
wherein the frequency calculating device calculates the viewing frequency every preset unit time and on the channel unit basis.

8. The information displaying apparatus according to claim 7,
wherein only when the updating is instructed, the updating device executes the updating using the frequency corresponding to the unit time to which a timing at which the updating is instructed belongs.

9. The information displaying apparatus according to claim 7,
further comprising an updating device for updating the content of the displayed program guide screen every unit time by using the frequency calculated in correspondence with the unit time.

10. An information displaying method executed in an information displaying apparatus for displaying a list of programs as a program guide on a channel unit basis on a display device, comprising:
a frequency calculating process of calculating frequency of viewing on the channel unit basis;
a screen generating process of generating, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and
a display control process of displaying the generated program guide screen on the display device,
wherein the order of displaying the channels in the channel group displaying columns is either ascending order or descending order of the calculated frequency.

11. A recording medium where an information displaying program is computer-readably recorded,
the program being for making a computer for controlling display in a display device function as the information displaying apparatus
wherein the information displaying apparatus is for displaying a list of programs as a program guide on a channel unit basis on a display device, comprising:
a frequency calculating device which calculates frequency of viewing on the channel unit basis;
a screen generating device which generates, based on the calculated frequency, a program guide screen used at the time of displaying the program guide on the display device, using a longitudinal axis as a time base and a horizontal axis as a channel axis, the program guide screen including, along the horizontal axis, columns displaying a group of channels in each of which programs are displayed along the time base; and
a display control device which displays the generated program guide screen on the display device,
wherein the order of displaying the channels in the channel group display columns is either ascending order or descending order of the calculated frequency.
